(19) United States
(12) Patent Application Publication
(10) Pub. No.: US 2008/0300898 A1
(43) Pub. Date: Dec. 4, 2008

(54) Document processing services

(76) Inventors: Belkacem Bacha, Canton, MI (US); Joseph M. Gagnier, Birmingham, MI (US); David A. Laporte, Livonia, MI (US); Shaun Zak Abshire, Wyandotte, MI (US); Douglas Semler, Dearborn Hts., MI (US); Michel Cordonnier, Ypsilanti, MI (US); Aashish Shah, Flint, MI (US); Bruce Young, Novi, MI (US)

Correspondence Address: UNISYS CORPORATION, UNISYS WAY, MAIL STATION: E8-114, BLUE BELL, PA, 19424, US

(21) Appl. No.: 11/807,796

(22) Filed: May 30, 2007

(51) Int. Cl. G06Q 50/00; G06F 17/30

(52) U.S. Cl. 705/1

(57) ABSTRACT

A document processing device is provided. A device service is configured to generate information concerning a document processed by the document processing device. A client interface is included in the device service and is configured to perform at least one of (a) publishing an event to a plurality of clients based on at least one of a status of the document processing device and the information and (b) providing an instruction to the document processing device based on a message from one of the plurality of clients. One or more application services are in selective communication with the device service and at least one of the clients.

### FIELD OF THE INVENTION

The present invention relates generally to techniques for providing document processing systems, and, in particular, a system and method for providing distributed processing systems for implementing document processing services.

### BACKGROUND

Document processing operations may involve distributed processing. A document processing device may be managed by an application running on a computer to which the document processing device is connected, e.g., using a Universal Serial Bus (USB) connection, local area network (LAN, or other interface). The application may remotely stop and start a scanning process, handle exceptions in the scanning process, etc. Further, such a remote application may perform analysis and/or reporting operations. For example, an image may be scanned by a document processing device and provided to a computer for analysis. Further, an image may be scanned by the document processing device, analyzed by the device or the computer, and further results of such analysis may be sent to a computer at a second location for reporting and archiving purposes, or for further analysis.

Accordingly, present document processing architectures generally require a one-to-one relationship between a controller application and a document processing device, where the application is running on a computer, i.e., a device controller, to which the document processing device is locally connected. Further, the device controller in the document processing device generally operates in the same operating system environment, e.g., a Microsoft® Windows® environment. To control a document processing device, the controller application generally communicates with the document processing device through an application programming interface (API). A controller application may thus control one or more document processing devices. However, multiple devices in an environment generally may only communicate with only one controller application, and in fact generally with only one instance of the controller application. Thus, a controller application generally communicates asynchronously with a document processing device.

In present architectures for document processing, it is generally difficult for multiple document processing devices to communicate with one or more instances of one or more control applications. In fact, present control applications are often limited to communicating with one document processing device at a time. It is further very difficult to connect devices and applications in different operating system and program code development environments.

### BRIEF DESCRIPTION OF THE DRAWINGS

FIG. 1 illustrates an exemplary document processing system.

FIGS. 2A-2E illustrate exemplary flows of data according to various embodiments.

FIG. 3 provides a detailed illustration of exemplary applications and application services.

FIG. 4 illustrates a user interface provided by a discovery manager, according to an embodiment.

FIG. 5 illustrates a user interface for an exception handler, according to an embodiment.

FIG. 6 illustrates a user interface for configuring and requesting the generation of reports, according to an embodiment.

FIG. 7 illustrates an exemplary summary level read rate report, according to an embodiment.

FIG. 8 illustrates an exemplary detail level report of a read rate by document type, according to an embodiment.

FIG. 9 illustrates an exemplary process flow for processing documents in the system of FIG. 1.

FIG. 10 illustrates exemplary process flow for processing an individual document in the system of FIG. 1.

FIG. 11 illustrates exemplary process for subscribing to events published by a device service, and for receiving such events in the system of FIG. 1.

### DETAILED DESCRIPTION

### I. System Overview

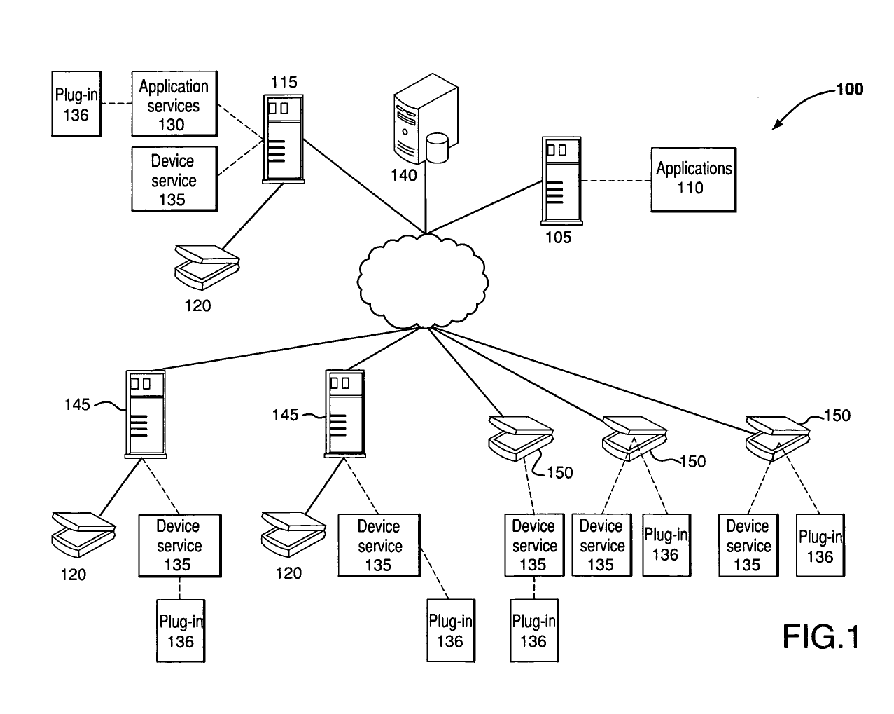

FIG. 1 illustrates an exemplary document processing system 100, including a network 101 that connects computers 105, 115, and 145, and also a database server 140 and document processing devices 150. Computer 105 includes one or more document processing applications 110. Computer 115 includes application services 130 and device service 135. Further, a document processing device 120 is connected to computer 115, e.g., by a Universal Serial Bus (USB) connection. Further, application services 130 may be embedded in a standalone document processing device 150. It is to be understood that applications 110 may be included on computer 115 or some other computing device connected to network 101 in addition to or alternatively to computer 105. Similarly, computer 115 need not be connected to device 120, and application services 130 and device services 135 could be included on computer 105 in addition to or alternatively to computer 115.

In the present exemplary illustration of system 100, computers 145 are distinguished from computer 115 in that computers 145 do not include application services 130, but are connected to at least one document processing device 120 and include device services 135. Further, standalone document processing devices 150 are similar to document processing devices 120, but have embedded device services 135 and application services 130, and are connected directly to network 101. A database server 140 or the like may be used for storing images and information about images provided by document processing devices 120 and/or 150.

Network 101 is generally a packet network. Accordingly, network 101 may be an Internet Protocol (IP) network or the like such as is known for transporting digital data packets. For example, network 101 may use protocols such as user datagram protocol (UDP), transmission control protocol (TCP), hypertext transfer protocol (HTTP), etc. Further, network 101 may include a variety of networks such as a wide area network (WAN), e.g., the Internet, a local area network (LAN), etc.

Computers 105, 115, and 145 may be any one of a number of known computing devices, such as a desktop computer, a laptop computer, a handheld computer, thin client, etc. Further, computer 145 could in fact be custom hardware, e.g., a device referred to as a “smartbox” that does not perform general computing operations but is configured to execute device services 135 and to support a peripheral device such as a device 120. Computers 105, 115, and 145 may connect to network 101 through any one of a number of protocols, such as those mentioned above. Further, the connection of a computer 105, 115, or 145, or 150 to network 101 may be either wired or wireless.

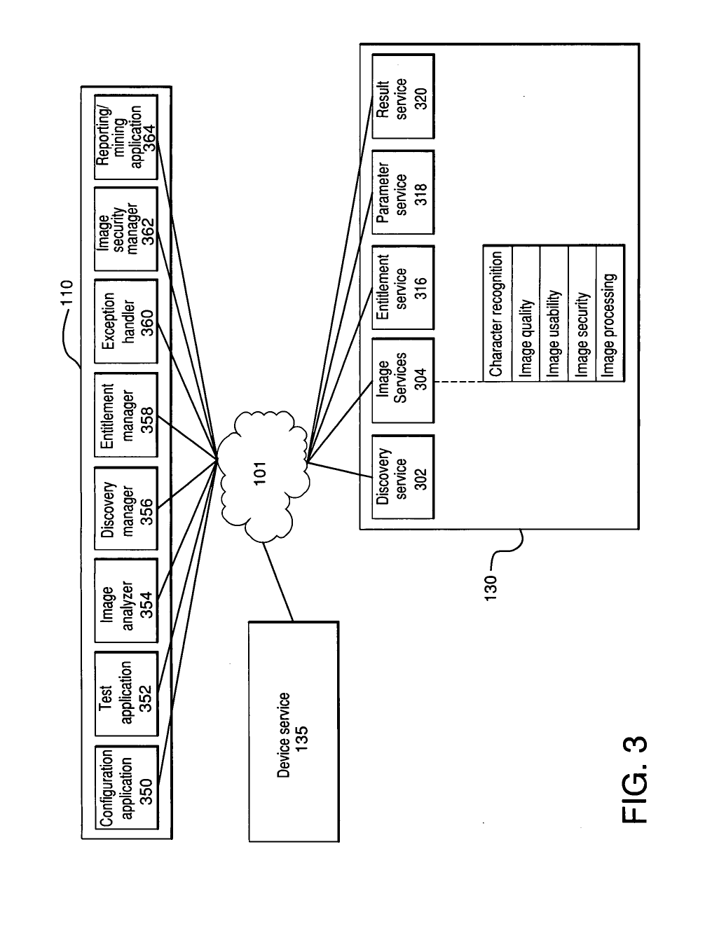

Document processing applications 110 may include a variety of different software applications for accessing, controlling, and/or receiving data from devices 120 and/or 150. Specific examples of applications 110 are discussed in more detail below with reference to FIG. 3.

Document processing devices 120 may include any device that includes a processor and memory, and that may be configured to capture document images. As mentioned above, devices 120 are generally configured to be connected to a computer 105, 115, or 145, e.g., through a USB connection. Devices 120 communicate with device services 135 on computer 105, 115, 145, etc., which services 135 in turn may communicate with one or more applications 110. Exemplary document processing devices 120 may include the SourceNDP, MyVision X, UEC Series, NDP 110, NDP Quantum Series, NDP 850, 1150, and 2000, etc., all manufactured by Unisys Corp. of Blue Bell, Pa. However, devices manufactured and/or sold by other vendors may also be used.

Application services 130 may be accessed by applications 110 to locate, configure, query, etc. device services 135. Application services 130 are discussed in more detail below with reference to FIG. 3.

Database server 140 may be connected to one of computers 105 or 115, but is generally accessible through network 101. Database server 140, as mentioned above, may be used for storing images captured by devices 120 and/or 150, as well as data about such images. Database server 140 generally includes a relational database management system (RDBMS), as is well known. An RDBMS generally employs the well known Structured Query Language (SQL) in addition to a language for creating, storing, editing, and executing stored procedures, such as the PL/SQL language mentioned above. However, it is to be understood that database server 140 may include some other kind of database such as a hierarchical database, a set of files, an application database in a proprietary format, etc. Database server 140 generally includes a computing device employing a computer operating system such as one of those mentioned elsewhere herein, although database server 140 may be included in one or more of computers 105, 115, etc.

Document processing devices 150 may include any device that includes a processor and memory, and it may be configured to capture document images, and further that may be configured to include device services 135, e.g., as embedded software as well as application services 130. Accordingly, document processing devices 150 may communicate with application services 130 through network 101 or as embedded within a device 150. Exemplary document processing devices 150 may include the devices mentioned above manufactured by Unisys Corp., or similar devices, provided that such devices are configured to include device services 135 and plug-in 136.

In general, computers 105, 115, and 145, database server 140, and document processing devices 120 and 150, may include one or more computing devices configured to communicate through network 101. As mentioned above, network 101 may include one or more networks, e.g., a local area network (LAN), wide area network (WAN), the Internet, or other network(s) for exchanging digital information, as is well known. Computing devices such as the foregoing may include any one of a number of computing devices, including, without limitation, a computer workstation, a desktop, notebook, laptop, or handheld computer, or some other computing device as is generally known, such as a Java™-enabled cellular telephone or similar device. Further, computing devices such as the foregoing may employ any of a number of computer operating systems, including, but by no means limited to, known versions and/or varieties of the Microsoft® Windows( operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. In an embodiment, document processing devices 120 and 150 include the Windows CE operating system distributed by Microsoft Corporation of Redmond, Wash. Further, in an embodiment, computers 105 and 115 include the UNIX operating system and computer 145 includes the Windows operating system.

Further, computing devices such as the foregoing may each include instructions executable by one or more computing devices such as those listed above. Such instructions may be compiled or interpreted from computer programs created using a variety of programming languages and/or technologies, including, without limitation, and either alone or in combination, Microsoft .NET, Java™, C, C++, Visual Basic, Java Script, Perl, etc. For example, in an embodiment, device services 135 and application services 130 are written according to .NET. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

### II. Data Flows

Applications 110, application services 130, and device services 135 may communicate according to an asynchronous model using Web Services Eventing (WS-Eventing) as described, for example in Don Box, Luis Felipe Cabrera, et al., Web Services Eventing (WS-Eventing) dated August 2004 and published by the World Wide Web Consortium on Mar. 15, 2006 on its website at www.W3C.org, the contents of which are fully incorporated herein by reference in their entirety. In the asynchronous model, applications 110 subscribe to application services 130, and an application 110 accordingly receives information published by application services 130 to which it has subscribed. Services 130 and 135 may be described according to an extensible markup language (XML) format such as Web Service Definition Language (WSDL) as is known for use in conjunction with WS-Eventing. WSDL is described in Erik Christensen, Francisco Curbera et al., “Web Services Description Language (WSDL) 1.1,” dated Mar. 15, 2001 and published by the World Wide Web Consortium on its website at www.W3C.org, the contents of which are fully incorporated herein by reference in their entirety. As described in the WSDL 1.1 document, WSDL includes support for Simple Object Access Protocol (SOAP), and in fact SOAP may be used in conjunction with WSDL in certain embodiments.

Events generated by services 130 and 135 are described in further detail below. However, it should initially be understood that services 130 and 135 generate various events that may be stored and/or acted upon by applications 110. Such events may include document images provided in real-time or near real time, other data events such as magnetic ink character recognition (MICR) code lines or optical character recognition (OCR) code lines, errors, warnings, information about image quality including image quality defects, user interface inputs, e.g. a user selection of a pushbutton on a device 120 or 150, a powering on or off of a device 120 or 150, etc. Further, applications 110, application services 130, and device services 135 may communicate according to a polled processing mode in which an application 110 must make a specific function or method call to an application service 130 to obtain information about a document processed by a document processing device 120 or 150.

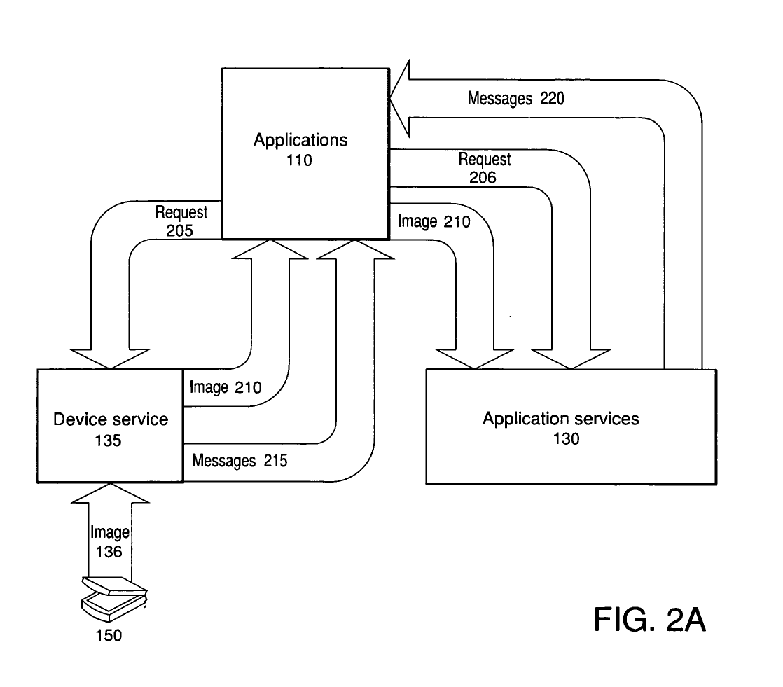

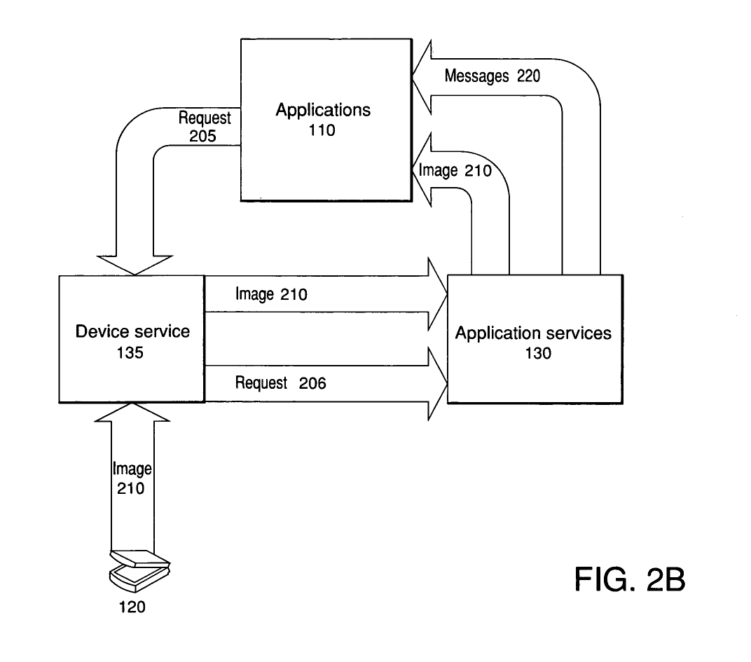

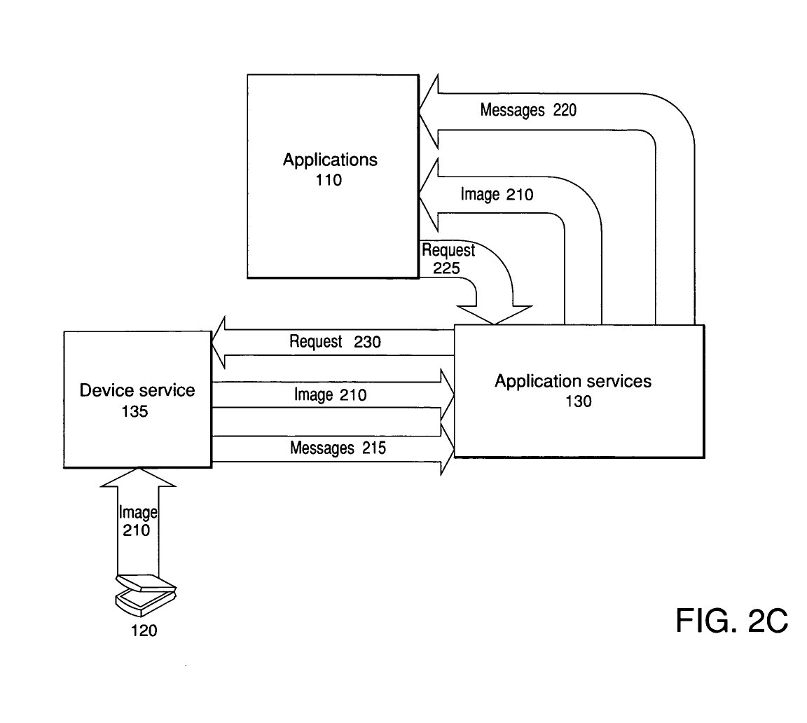

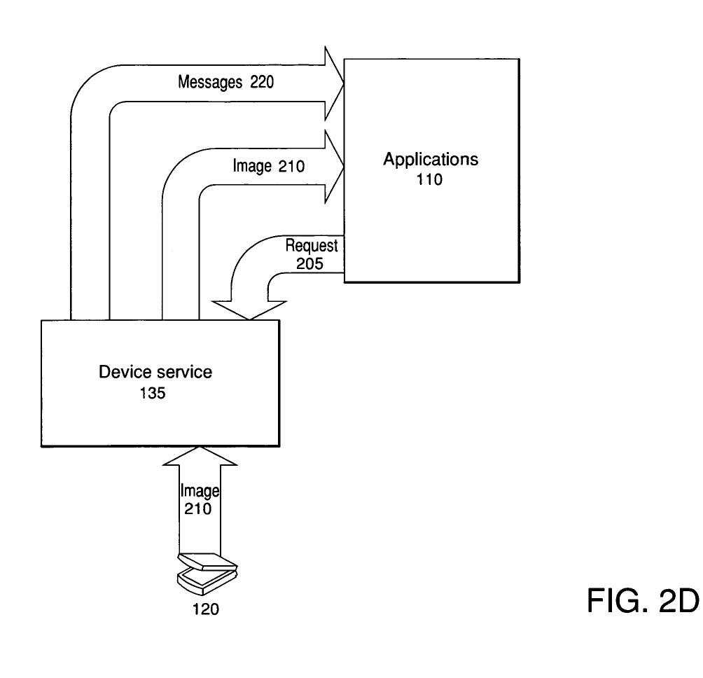

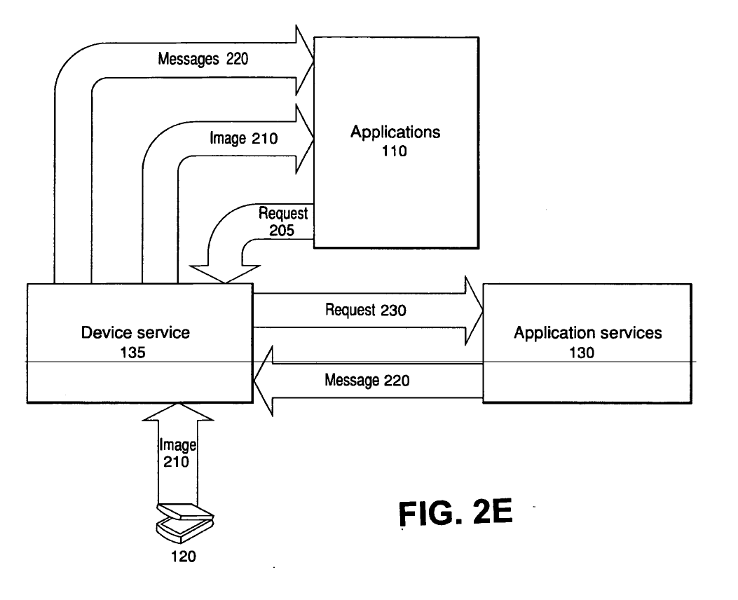

FIGS. 2A, 2B, 2C, 2D and 2E illustrate exemplary flows of data according to various embodiments.

Turning first to FIG. 2A, application 110 is shown as sending a request 205 to device service 135. Such a request 205 may be a call to a method or function made available by device service 135. For example, a request 205 may be provided according to WSDL as described above. Methods made available by device service 135 according to an embodiment are discussed further below, and specific examples are described further in Table 1 below. Briefly, such methods may allow for configuration of a device 120 or 150, for an instruction to return information regarding a document scanned by device 120 or 150, for a request for information regarding status or state of a device 120 or 150, etc.

FIG. 2A further illustrates an image 210 being acquired by a device 150. Note that a device 120 along with a computer 145 could have as easily been included in FIG. 2A in lieu of the device 150 illustrated therein. As mentioned above, in an embodiment, devices 120 and 150 operate to scan documents, thereby rendering images 210. Request 205 may be a request for information about image 210 and/or for image 210 itself. Information about images 210, devices 120 and 150, etc. that may be obtained from device service 135 according to an embodiment is discussed further below, and moreover specific examples are provided in Table 2 below. Further, in addition to devices 120 and 150, other types of devices may be controlled by device services 135 including plug-in 136, such as devices that may work in conjunction with document processing devices 120 and 150, e.g., fingerprint scanners, magnetic stripe readers, display and printing devices, etc.

Information about images 200 and, devices 120 and 150, etc. may be provided by device service 135 in a message 215. As further shown in FIG. 2A, in response to request 205, device service 135 provides image 210 along with message 215 to application 110. Advantageously, message 215 and image 210 may be events that are provided asynchronously by device service 135 to application services 130 and/or applications 110.

As discussed further below, device service 135 may perform limited processing with regard to an image 210. Accordingly, application 110 may send a request 206, along with image 210, to an application service 130 for further processing of the image 210. For example, as described further below, an application service 130 may analyze the quality, usability, etc. of the image 210. Results of such analysis, or any information in response to the request 206, may be provided by application service 130 to application 110 in a message 220. Like message 215, message 220 may be an event provided asynchronously by application service 132 application 110. Further, as discussed below with reference to FIG. 2E, device services 135 can send requests and receive messages from application services 130 without intervention from applications 110. In fact, if desired, device services 135 may perform substantially all of the operations of application services 130.

FIG. 2B illustrates a flow of data according to an embodiment that is slightly different than the flow illustrated in FIG. 2A. As shown in FIG. 2B, request 206 and image 210 are provided to application service 130 directly by device service 135. Image 210 and message 220 are provided from application service 132 application 110 as discussed above with respect to FIG. 2A.

FIG. 2C illustrates yet another flow of data according to an embodiment. As shown in FIG. 2C, application 110 sends a request 225 to application service 130. Request 225 is similar to request 205 discussed above with respect to FIG. 2A, but calls a method or function in application service 130, rather than a method or function in device service 135. Application service 130 then sends a request calling a method or function in device service 135. In response, device service 135 provides image 210 and message 215 to application service 130, which in turn provides image 210 and message 220 application 110 as discussed above.

FIG. 2D illustrates yet another flow of data according to an embodiment. In this embodiment, application service 130 is not included, or is at least bypassed. Application 110 sends request 205 to device service 135. In response to request 205, device service 135 sends image 210 and message 220 directly to application 110.

FIG. 2E illustrates yet another flow of data according to an embodiment. In this embodiment, application 110 sends a request 225 to device service 135, which in turn sends a request 230 to application service 130. Request 230 is similar to other requests described above, and is a request from device service 135 to application service 130 on behalf of application 110 to perform an operation provided by application service 130. Message 220 in response to requests 230, and indirectly in response to request 225, is provided to application 110 through device service 135.

It is to be understood that embodiments are possible and likely in which data flows through elements not shown in FIGS. 2A-2E. For example, an application programming interface (API) may be interposed between application 110 on the one hand, and services 130 and 135 on the other, so that application 110 may communicate through a single interface with both services 130 and 135. Similarly, an intermediate programming layer may allow services 130 and 135 to communicate with multiple applications 110 through a single interface. Further, although network 101 is not shown in FIGS. 2A-2D, it is to be understood that application 110, application services 130, and device services 135, may communicate via network 101 as discussed above with reference to FIG. 1.

Moreover, embodiments including flows of data different from those illustrated in FIGS. 2A-2E are possible. In particular, FIGS. 2A-2E each show a single application 110 and a single device 150 associated with a single device service 135. However, as better seen in FIG. 1, applications 110 and device services 135 may have a many-to-many relationship. Thus, multiple applications 110 may subscribe to a single event source, e.g., a device service 135. Conversely, a single application 110 may subscribe to events from multiple event sources, e.g., device services 135, application services 130, etc.

Further, as will be clear below, many requests 205, 206, etc. will result in a message 215, 220, etc. without an image 210. Indeed, applications 110 and/or application services 130 may subscribe to events that are published as an image 210, a message 215, 220, etc., and therefore a request 205, 206, etc. from a client is not necessary to trigger a message 215, 220, etc. In general, services 130 and 135, and applications 110, follow the known publish-and-subscribe model according to which events are published to client applications by web services. Accordingly, event subscriptions persist even when devices 120 and 150 are powered off, and an application 110 generally may not only subscribe to receive events from a service 130 or 135, but may also unsubscribe from, renew, etc. such services. Services 130 or 135 may grant or deny subscriptions, e.g., grant or deny access to an application 110, grant or deny renewals, provide multiple subscriptions to multiple applications for multiple event types, etc.

### III. Applications and Services

FIG. 3 provides a detailed illustration of exemplary applications 110, application services 130, and device services 135.

In general, services 130 and 135 provide the advantage of allowing coming processing operations, standards, regulatory rules, etc. to be maintained in a way that is transparent to a potentially large and potentially diverse groups of applications 110. For example, rules for image compression, encryption, formatting of various document fields, image usability analysis, image quality analysis, funds transfer rules, exception handling, error reduction, and many more kinds of rules may be updated in services 130 and/or 135 independently of, and without making any changes to, applications 110. Further updates to services 130 and/or 135 will be very quickly and efficiently deployed to all client applications 110.

As described in further detail below, various application services 130 and device services 135 may accept various inputs and provide various outputs. Some inputs may be provided by a user, and some outputs may be viewed by a user. Accordingly, it is to be understood that applications 110 may include one or more graphical user interfaces (GUIs) or the like to allow a user to provide such inputs and to view such outputs. Generally such GUIs are provided in a known web browser or the like according to program instructions on computer 105.

A. Application Services

Applications services 130 in an embodiment run in a Windows XP environment on a computer such as computer 115. Application services 130 may include a discovery service 302, image services 304, and entitlement service 316, a parameter service 318, and a result service 320. Application services 130 generally include a client interface that is an application programming interface or the like through which methods in an application service 130 may be called by clients such as applications 110. Further, application services 130 may publish events through the client interface. For example, such a client interface may accept input and provide output formatted according to extensible Markup Languag (XML).

Discovery service 302 may be used by an application 110 to determine the identities and locations of document processing devices 120 and 150 and services 130 and 135 for which the application 110 may subscribe to receive information and/or provide input. Discovery service 302 thus essentially provides a directory or registry for dynamically locating devices 120 and 150 and device services 135. For example, such a registry may be formatted according to the known Universal Description, Discovery, and Integration (UDDI) standard, and may include a description and a physical location i.e., a Uniform Resource Locator (URL) for each device and service entered in the registry. Applications 110 may locate devices 120 and 150 and/or services 130 and 135 automatically, e.g., according to program instructions. Application 110 may also include a graphical user interface (GUI) or the like, e.g., such as may be displayed in a web browser or the like, to allow a user to specify or to manually determine a physical location for devices 120 and 150 and/or services 130 and 135. Such a GUI may also be used to allow a user to determine whether devices 120 and 150 and/or services 130 and 135 automatically located by an application 110 should be subscribed to.

One or more image services 304 may provide one or more renditions of a scanned document image, e.g., in a known format such as that set forth by the Joint Photographic Experts Group (JPEG), or the Comité Consultatif International Téléphonique et Télégraphique (CCITT), etc. Such image renditions may be displayed in an interface provided by application 110, e.g., in a display of computer 105. Further, image services 304 may provide a variety of image analysis operations, and image renditions may be provided in conjunction with such operations.

Image services 304 may include character recognition services 306 such as courtesy amount recognition (CAR) and legal amount recognition (LAR). Such character recognition services may make use of Intelligent Character Recognition (ICR) technology. As is known, ICR may use information obtained from Optical Character Recognition (OCR) and/or Magnetic Ink Character Recognition (MICR).

Image services 304 may further include image quality services 308 that perform image quality analyses, thereby providing real-time or near real time assessments or offline of image quality to applications 110. For example, as is known, the American National Standards Institute (ANSI) has approved the X9.100-180 Specifications for Electronic Exchange of Check and Image Data. Accordingly, image services 304 may be configured to detect image quality defects as defined in the foregoing specifications, and may further be configured to generate Image Quality Flags (IQFs) for one or more image renditions of a document processed by a document processing device 120 or 150.

An IQF is generally activated when a particular image quality metric exceeds one or more predetermined thresholds, e.g., thresholds defined according to user input. An IQF may be dependent upon a specific image rendition, e.g., whether the image rendition is a black/white or a grayscale rendition. Further, an IQF may be dependent upon a particular portion of a document processed in a device 120 or 150, e.g., whether the front or the back of a document is being processed. Providing an IQF to application 110 at the time of document capture allows problems with image capture to be quickly corrected, and for images to be efficiently recaptured to ensure that only quality images are presented through application 110. For example, it may be possible to easily remedy detected streaks in an image by simply cleaning a camera. It further may be possible to easily repair a folded corner of a document, or to correct the backwards feed of a document into a device 120 or 150.

In conjunction with analyzing image quality, image services 304 may further include image usability services 310 that provide an assessment of image usability. As is known, the Check Processing for the 21st Century Act mandates that banks accept image replacement documents (IRDs), which are defined in the American National Standard Specifications for an Image Replacement Document—IRD, X9.100-140 (ANS X9.100-140). Image quality analysis that generates IQFs generally applies to an entire document. Accordingly, even where no IQFs are raised, a document may be unusable for its intended purpose, e.g., because a particular portion or field in a document is unreadable or unusable. For example, a document may be broken into various sections or fields, and various usability tests may be applied to each such field. For example, fields that might be assessed on the front and back of a check include date, payee name, courtesy amount, legal amount, signature, memo line, and endorsement. A usability assessment may determine whether a document image retains sufficient information with respect to each field, and may further assess the legibility of each field.

Image services 304 may further include image security services 312. Image security services 312 generate a digital signature for images captured in document processing devices 120 and 150 using image data and a private key that is part of a public/private key pair, such key pairs being well known. Digital signatures may be stored in files on a computer, in database 140, in devices such as devices 120 and 150, etc. The use and benefits of digital signatures for documents such as financial instruments, e.g., checks, are well known.

Image services 304 may further include image processing services 314. As mentioned above, image services 304 may provide one or more renditions of an image captured in device 120 or 152 and application 110. Post-capture processing on such images may be performed by image processing services 314. For example, it may be desirable to select a portion of a rendered image for storage or further analysis, to convert a grayscale image to a black/white image, etc.

Entitlement service 316 validates the feature or features of image services 304 that an application 110 is entitled to access. For example, application 110 may generate a license request to entitlement service 316 to authorize particular features of image services 304, e.g., licensed features or features that a user of application 110 has purchased. Entitlement service 316 may also store usage information in database 140, and/or report usage information to a remote server over network 101.

Parameter service 318 is responsible for storing parameter file structures, e.g., in database server 140. Accordingly, parameter service 318 allows image services 304 to retrieve parameter files at runtime. Further, parameter service 318 may synchronize parameter structures being used simultaneously by multiple instances of image services 304. Parameters stored in parameter files and placed in parameter structures for image services 304 include values for IQFs, discussed above, values indicating portions of a document of interest to image usability services 310, etc.

Results service 320 allows for storage of image results from image services 304 on an asynchronous basis. That is, results service 320 supports audit logs and image processing results from multiple applications 110 running at different times and possibly across different networks, involving different or possibly the same devices 120 and 150. In an embodiment, results data is saved in an XML file format in database server 140. Further in an embodiment, results service 320 uses known Microsoft Message Queuing (MSMQ) technology to manage the receipt and storage of results.

B. Device Services

With respect to a device 120, a device service 135 runs on a computer 145 to which the device 150 is connected, e.g., via a Universal Serial Bus (USB) connection. Further, device service 135 in an embodiment runs in a Windows CE environment on devices 150. Device service 135 may be accessed by applications 110 and/or application services 130 to control some or all of the operation of devices 120 and 150. Device service 135 generally supports the capture of an image by a device 120 or 150, and renders an image, e.g., in a JPEG format. Further, device service 135 generally includes all or a subset of the operations provided by application services 130, including operations substantially as described above with respect to image quality service 308 and image security service 312.

Device service 135 includes methods that may be called to configure most if not all of the configurable settings in a device 120 or a device 150, as well as methods that may be called to obtain information concerning a present status of various aspects of a device 120 or a device 150. Such methods are generally called by formatting and providing an XML document to device service 135, e.g., according to WSDL as described above. Methods included in device service 135 in an exemplary embodiment include those described below in the section headed “Exemplary Services Methods.”

Device service 135 generally includes a client interface that is an application programming interface or the like through which methods in device service 135 may be called by clients such as applications 110 and application services 130. Further, device service 135 may publish events through the client interface. For example, such a client interface may accept input and provide output formatted according to XML.

C. Plug-In

In some cases, device 150, and/or device service 135, or application service 130 may include a plug-in 136 that works in conjunction with device service 135. Plug-in 136 is generally a module of a device service 135 or application service 130, and may include a dynamic link library (DLL) or the like. Advantageously in the case of a device 150, plug-in 136 may be compiled for a native environment, e.g., for the native environment of device 150, and then may be downloaded to device 150 for execution.

Example of operations performed by plug-in 136 include providing processing rules governing the endorsement of a document, the “pocket” of a device 150 to which a document is sent, capturing a document image, identifying a type of document, etc. may be implemented using plug-in 136 on device 150. Native code for device 150 provides the advantages of increasing programming flexibility and further generally providing execution times that are shorter than could be obtained with non-native code, because control decisions are made according to instructions executed in a processor in device 150, rather than by a remote application 110 or a remote application service 130. Thus, a method in device service 135 may be called to initiate document processing, whereupon device service 135 may instruct plug-in 136 to commence such processing, and whereupon processing rules implemented in plug-in 136, such as the afore-described rules, are used to process documents in device 150. However, such native code is more difficult to port to other hardware platforms. A plug-in may also be included as part of devices services 135 and application services 130 to control decisions based on custom application software.

Device service 135 may include program instructions for downloading and installing plug-in 136, e.g., an InstallFile( ) method as described below in Table 1. For example, plug-in 136 may be downloaded to a device 150 from a computer such as computer 105 or computer 115. Plug-in 136, e.g., as a module within device service 135, may receive instructions or requests from device service 135, and may provide information to device service 135 to be used, e.g., in messages 215.

D. Applications

Although shown running on computer 105 in FIG. 1, applications 110 may be installed and run on multiple computing devices including multiple programming and operating system environments. For example, while certain applications 110 may run in some form of a Windows environment, other applications 110 may run in some form of a UNIX environment. A wide variety of applications 110 are possible, including a configuration application 350, a test application 352, an image analyzer 354, a discovery manager 356, an entitlement manager 358, an exception handler 360, and image security manager 362, a reporting/data mining application 364, and image archive 366. As illustrated in FIG. 2, applications 110 generally communicate with services 130 and 135 through network 101.

Configuration application 350 is generally used to obtain information about, and to configure, a device 120 or 150. To perform these operations, configuration application 350 communicates with device services 135 associated with the device 120 or 150 to be configured. In general, such elements may include items such as the speed at which a feeder in a device 120 or 150 operates, a format (e.g., JPEG, etc.) for an image captured by device 120 or 150, a physical length of documents whose images are to be captured by the device 120 or 150, a configuration for a magnetic ink character recognition (MICR) reader, a configuration for an optical character recognition (OCR) reader, etc., to name but a few. Numerous other elements that may be configured in a device 120 or 150 according to exemplary embodiments are described below. Also described below are methods in device service 135 that may be called by configuration application 350 to configure a device 120 or 150.

Test application 352 is sometimes referred to as an “exerciser.” Test application 352 may communicate with application services 130 and/or device service 135 to initiate, control, and receive information about documents processed by devices 120 and 150. The purpose of test application 352 is to provide for the testing or trial of application services 130, device service 135, and/or devices 120 or 150. Accordingly, test application 352 may invoke generally any method made available by services 130 or 135. Further, test application 352 may generally subscribe to any event published by services 130 or 135.

Image analyzer 354 generally subscribes to events published by device services 135 and image services 304. For example, character recognition services 306 may provide image analyzer 354 with information about the content of a document, e.g., the amount of a check obtained by courtesy amount recognition (CAR) and/or legal amount recognition (LAR) technologies. Image quality services 308 may provide an IQF as described above. Further, image analyzer 354 may obtain usability assessments provided by image usability services 310. Image analyzer 354 may obtain information from image security services 312, or such information may be provided to image security manager 362, discussed below. Further, image analyzer 354 may obtain one or more renditions of the document image, e.g., in JPEG, TIF, CCITT formats, etc., from image processing services 314.

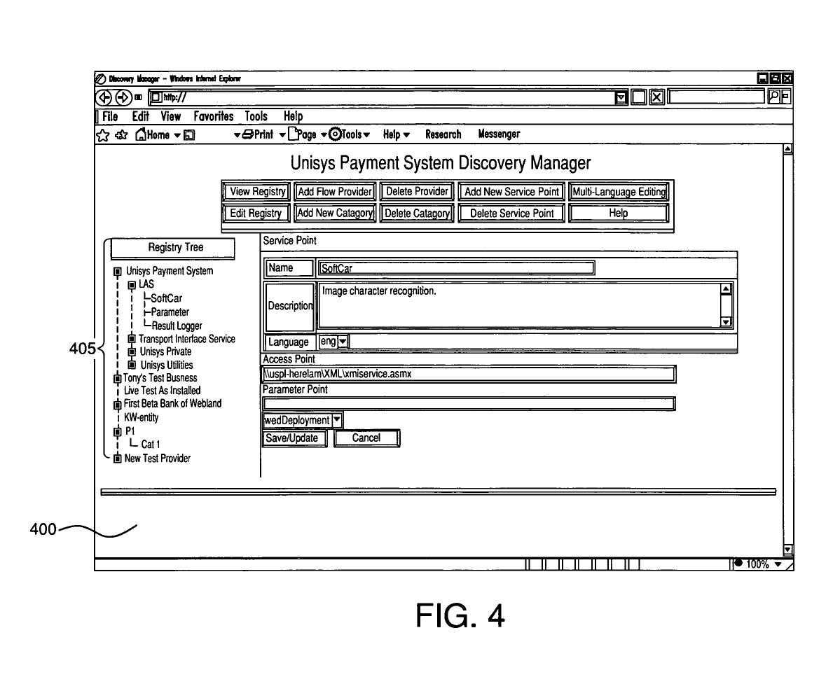

Discovery manager 356 provides a user interface, generally a GUI, to discovery service 302. A user interface 400 provided by discovery manager 356 in a standard web browser according to an embodiment is shown in FIG. 4. Registry tree 405 includes devices 120 and 150 and services 130 and 135 that may be accessed by applications 110. Specifically, items listed in Registry tree 405 not preceded by a “+” or “−” icon are devices 120 or 150, or services 130 or 135, that may be accessed by applications 110. Items preceded by a “+” or “−” icon are categories of devices 120 or 150, or services 130 or 135 included in registry tree 405 to support navigation by a user. As shown in FIG. 4, user interface 400 includes a form field for specifying an access point 410, e.g., a uniform resource locator (URL) or other network address for a device 120 or 150 or service 130 or 135. In general, through interface 400, a user may add or delete entries to registry tree 405, or otherwise edit registry tree 405.

Entitlement manager 358 provides a user interface to allow a user to request and obtain entitlement to services 130 and 135 through entitlement service 316. Entitlement manager 358 may also be used to monitor usage of services 130 and 135 to ensure compliance with a license for such services.

Exception handler 360 displays information relating to exceptions reported by services 130 and/or 135. Generally an exception refers to an item that is not correctly processed by a device 120 or 150. With respect to an exception, exception handler 360 may display some or all of the following: a message describing the exception, a list of documents, including, if applicable, code lines, for which exceptions have been raised, and images, if available, of exception documents. Exceptions are generally events passed from devices 120 or 150 to exception handler 360. Exception handler 360 may also receive warnings, which are similar to exceptions, but relate to items whose processing could indicate a problem with a device 120 or 150 even if the item was correctly processed.

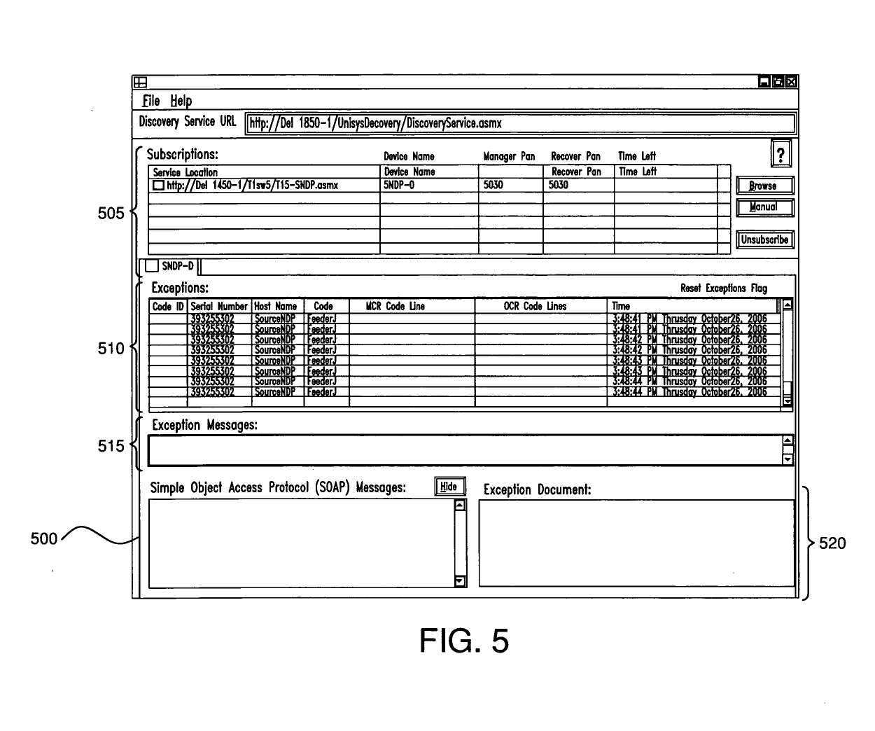

FIG. 5 illustrates a user interface 500 for exception handler 360, according to an embodiment. Subscription window 505 lists services 130 and/or 135 to which exception handler 360 has subscribed. Exception window 510 lists exceptions reported to exception handler 360. Messages window 515 displays any textual messages or descriptions related to an exception highlighted in exception window 510. Images window 520 displays an image, if any, for a document related to a highlighted exception in window 510.

Image security manager 362 generally interacts with image security service 312. Image security manager 362 is used to set security options, generate key pairs, export certificate requests, and import certificates for image security provided by services 130 and/or 135. Further, image security manager 362 may be used to activate image security for image 210, which is processed through device service 135 according to what is sometimes referred to as “level-2” security because it requires a password. The password is used to activate image security after the security system has been idle for a configurable period of time.

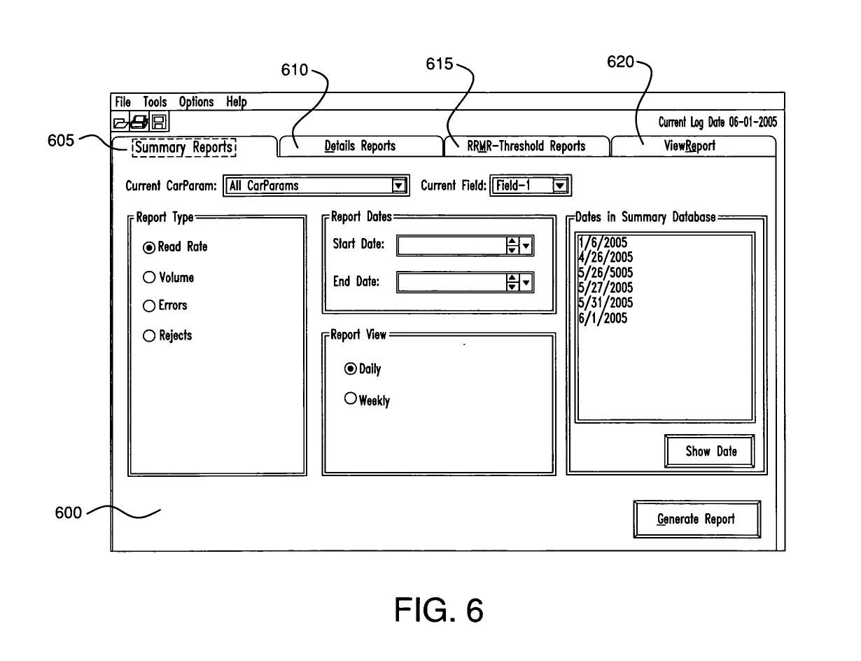

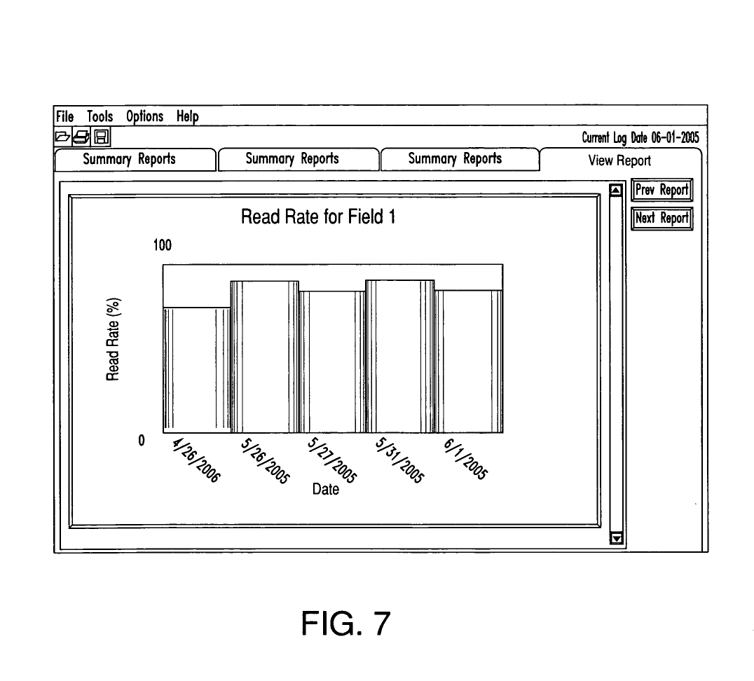

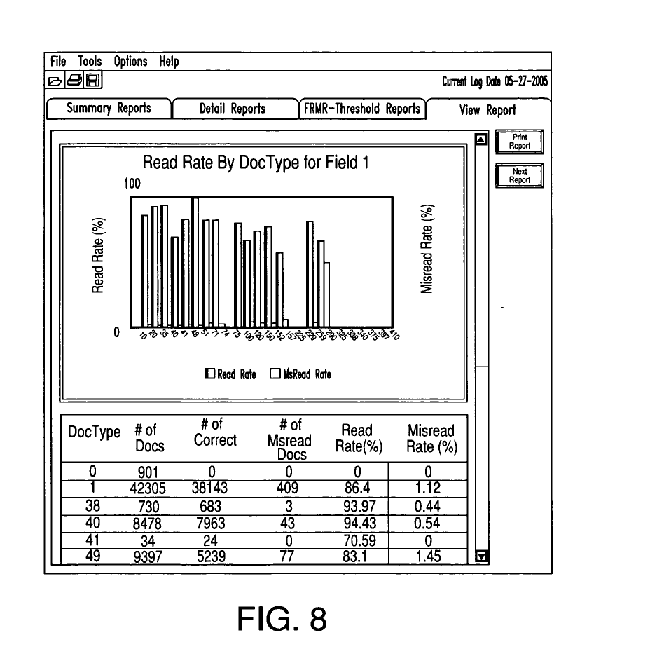

Reporting/data mining application 364 is used to log and provide reports on character recognition data and other results of processing documents in devices 120 and 150. Such data is generally stored in database server 140, sometimes only for a predetermined period of time in order to avoid exceeding space constraints. FIG. 6 illustrates a user interface 600 for configuring and requesting the generation of reports, according to an embodiment. Standard reports that may be provided in an odd event include a read rate and misread rate (RR/MR) report showing character recognition performance for one or more fields on a document, a volume report showing a number of documents processed within a specified period of time, an error report displaying a percentage of documents that have recognition error codes returned from character recognition engines in services 130 and/or 135, a reject report that displays a percentage of documents with an unsuccessful recognition field status, and a throughput report that displays a number of documents processed over time. User interface 600 includes a tab 605 for summary reports, a tab 610 for detail reports, a tab 615 for RR/MR report, in a tab 620 for viewing reports. For example, FIG. 7 illustrates an exemplary summary level read rate report, according to an embodiment. FIG. 8 illustrates an exemplary detail level report of a read rate by document type, according to an embodiment.

It is to be understood that some or all of the foregoing applications 110 may be combined or consolidated into a single application 110, or at least fewer applications 110 that are described above. Further, such applications 110 may be presented in a single or common graphical user interface. For example, test application 352 and image analyzer 354 may often be combined into a single application and/or presented in a single graphical user interface.

### IV. Process Flows

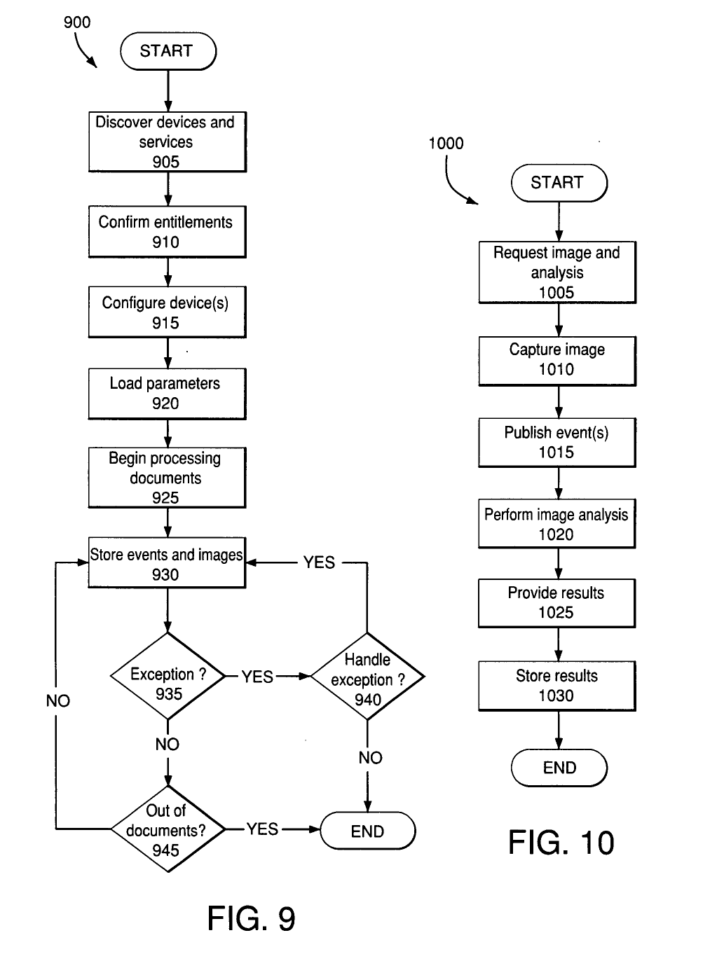

FIG. 9 illustrates an exemplary process flow 900 for processing documents in system 100. It is to be understood that the flow of data, e.g., requests, messages, events, etc., in process flow 900, and also process flow 1000 described below, may occur as described above with respect to FIGS. 2A-2D.

In step 905, discovery manager 356 accesses discovery service 302, which is used to discover available devices 120 and/or 150 along with associated device services 135. Accordingly, particular devices 120 and/or 150 that are available, e.g., via network 101, may be selected for processing documents. Further, particular application services 130 and/or device services 135 may be selected for processing documents.

Next, in step 910, entitlement manager 358 accesses entitlements service 316, which is used to confirm a user's right to access and use the devices 120 and/or 150 and services 130 and/or 135 selected in step 905. The remaining description of process 900 assumes that such entitlements were confirmed in step 910.

Next, in step 915, configuration application 350 is used to configure devices 120 and/or 150 selected in step 905. Certain items that may be configured were mentioned above, and further detailed examples are provided below of numerous elements in devices 120 and/or 150 that may be configured. Configuration application 350 generally also selects or identifies a set of parameters to be used by application services 130 in processing documents. Examples of such parameters are provided above.

Next, in step 920, parameter service 318 loads, e.g. into a memory of computer 115, parameters identified in step 915 above.

Next, in step 925, document processing is commenced. For example, an application such as test application 352, sometimes referred to as an “exerciser,” may be used to initiate and control document processing in system 100. As discussed above, in some embodiments, device 150 may include plug-in 136, which plug-in 136 may provide processing rules for controlling processing of documents in device 150.

Next, in step 930, image analyzer 354 receives renditions of images 210 and information about such images, e.g., events 215, e.g., from image services 304. A process whereby image analyzer 354 receives such images 10 is discussed in more detail below with reference to FIG. 10.

Next, in step 935, test application 352 determines whether any exceptions have been received concerning documents being processed in system 100. For example, if a feeder is jammed, a document attempted to be processed is the wrong size, etc., an exception may be raised and provided by device service 135. If an exception is raised, step 940 is executed next. Otherwise, process 900 proceeds to step 945.

In step 940, test application 352 determines whether exception received in step 935 has been handled. Test application 352 may be programmed to wait a certain amount of time for exception to be handled, or to receive the user input indicating that an exception has been handled, e.g., that ajammed feeder has been cleared. If test application 352 receives an indication that an exception has not been handled, process 900 ends. However, if an exception is handled, process 900 returns to step 930.

In step 945, test application 352 determines whether devices 120 and/or 150 selected in step 905 have run out of documents, been powered off, or otherwise are indicated to have completed processing documents. If so, process 900 ends. However, if documents remain to be processed, process 900 returns to step 930.

FIG. 10 illustrates an exemplary process flow 1000 for processing an individual document in the system of FIG. 1.

In step 1005, image analyzer 354 requests an image 210 and information about the image 210. As discussed above, in many embodiments, image 210 and message 215 are provided to image analyzer 354 by application services 130 and/or device services 135, and therefore step 1005 may be unnecessary.

Next, in step 1010, device 120 or 150 captures a document image 210.

Next, in step 1015, device service 135 publishes one or more events related to document image 210 to one or more applications 110, application services 130, etc. For example, device service 135 may cause the document image 210 captured in step 1010 to be provided to image services 304 and/or may provide other information as mentioned above.

Next, in step 1020, image services 304 analyze the image 210, e.g., as described above with reference to FIG. 3.

Next, in step 1025, image services 304 provide the results of the analysis performed in step 1020, generally along with the image 210, to image analyzer 354, e.g., as an event 215.

Next, in step 1030, image analyzer 354 generally displays at least some of the information received in step 1025 in a user interface, and also stores such information, e.g., a log, and database server 140, etc.

Following step 1030, process 1000 ends.

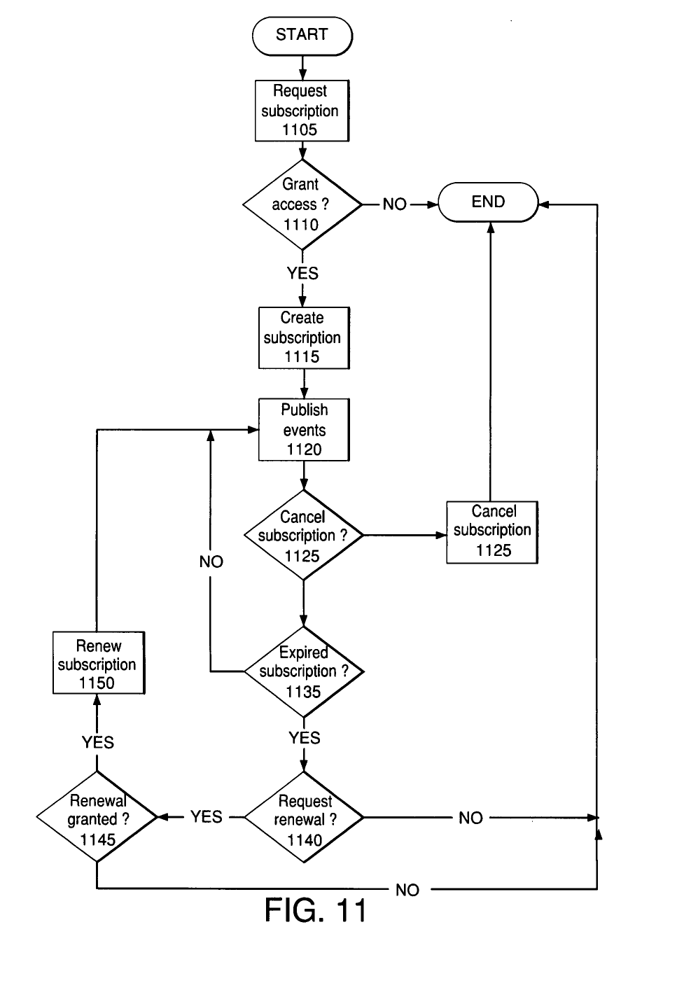

FIG. 11 illustrates exemplary process 1100 for subscribing to events published by device service 135, and for receiving such events.

In step 1105, a client such as an application 110, application service 130, etc. requests a subscription from device service 135.

Next, in step 1110, using known authentication techniques, device service 135 determines whether to provide the subscription requested in step 1105. For example, authentication may be performed by standard web services procedures such as security features provided by .NET. Further, this step 1110 is omitted in some embodiments; it is not necessary for device service 135 to authenticate subscribers.

Next, in step 1115, device service 135 creates a subscription for the requesting application 110, application service 130, etc. Device service 135 may include a registry or other database of subscribers to which device service 135 is to publish various events. Device service 135 generally makes available multiple events to clients such as applications 110, application services 130, etc. Note that it is generally not necessary or desirable for most clients to subscribe to all of the events published by a device service 135.

Next, in step 1120, device service 135 publishes events to clients such as applications 110, application services 130, etc. that have requested them.

Next, in step 1125, device service 135 determines whether it has received a request to cancel a subscription from a client, e.g. an application 110, an application service 130, etc. If so, step 1130 is executed next. Otherwise, step 1135 is executed next.

In step 1130, the subscription indicated in step 1125 is canceled. Process 1100 ends following step 1130.

In step 1135, device service 135 determines whether a subscription has expired. Such a determination is generally made periodically for all subscriptions registered in a device service 135. If a subscription has expired, step 1140 is executed next. Otherwise, process 1100 returns to step 1120.

In step 1140, device service 135 determines whether it has received a request to renew the subscription determined to be expired in step 1135. If so, step 1145 is executed next. Otherwise, process 1100 ends.

In step 1145, device service 135 determines whether to grant the request for renewal received as discussed above with respect to step 1140. If the request for renewal is not to be granted, process 1100 ends. Otherwise, step 1150 is executed next.

In step 1150, the subscription that was the subject of the renewal request received as discussed above with respect to step 1140 is renewed. Step 1120 is then executed following step 1150.

### V. Exemplary Services Methods

Table 1 lists and describes methods made available by devices service 135 in an embodiment. These methods are listed by way of example only, and other methods may be included in device service 135. Moreover, certain of these methods, and also other methods, may be made available by applications services 130.

TABLE 1

| Method | Description |
|---|---|
| GetDocument ( ) | Retrieve the data for the oldest processed document on a |
| | device. Normally, only completely processed items will be |
| | returned. If a client application does not have a separate |
| | exception handler, it may request that exception |
| | documents also be returned. |
| GetState ( ) | Returns a snapshot of the current service state. |
| GetStatistics ( ) | Returns statistics from a device. |
| PerformAlertActions ( ) | Causes a device service to perform actions that are |
| | specified in the current configuration that are associated |
| | with the given alert event. Note that a service may be |
| | configured to associate user interface actions with an alert |
| | event. |
| ResetStatistics ( ) | Resets an individual statistic, or all (writable) statistics on |
| | a device. |
| SendDataToProcessingRulesPlugIn | Sends data to a processing rules plug-in code module on |
| ( ) | a device. This method is only valid in a |
| | ‘DocumentProcessing’ state. The format of the data is |
| | defined by the processing rules plug-in. |
| StartFlow ( ) | Three flow modes are generally available - an auto feed |
| | mode, a single feed mode, and a document calibration |
| | mode. |
| StopFlow ( ) | An application should call this method in a device service |
| | when it is done controlling the device, it needs to change |
| | the flow mode, or if it needs to immediately stop the |
| | processing of documents. |
| GetCapabilities ( ) | Returns a list of machine capabilities (e.g. whether or not |
| | the machine is capable of OCR, number of pockets |
| | supported by the device, etc). |
| GetConfiguration ( ) | Returns the current machine configuration. |
| SetConfiguration ( ) | Sets the configuration options for a device. |
| ImgSecConfigure ( ) | Requests a change of the mutually exclusive state relating |
| | to Configuration mode. Its use is: |
| | to request Configuration mode |
| | to maintain Configuration mode |
| | to exit Configuration mode |
| | Only one client can be in Configuration mode at any one |
| | time. |
| ImgSecSetPassword ( ) | Changes the current Image Security password, or |
| | establishes one initially. Note: all other Image Security |
| | Web Service methods (except ImgSecReset) return an |
| | error if a password has not been assigned. This method |
| | can also be used to check an existing password. To do |
| | this, enter the same password for both old and new |
| | passwords. |
| ImgSecCreateKeypair ( ) | Creates a keypair. The service fails if a Keypair already |
| | exists (in which case call ImgSecDeleteKey first). |
| ImgSecCreateCertificateRequest ( ) | Creates a Certificate Request. This can be used to |
| | request a Certificate via a vendor website. |
| ImgSecSetCertificate ( ) | Sets a Certificate. An error is returned if the Public Key in |
| | the Certificate does not match that of the specified |
| | Keypair. Also, an error is returned if the Certificate |
| | already exists (must call ImgSecDeleteKey first with |
| | CertOnly = true). |
| ImgSecSetParams ( ) | Sets Image Security parameters. Note that |
| | ‘EnabledKeypair’ is either 1 or 2 to determine which |
| | keypair is to be used for signing, or it can be 0 to disable |
| | signing. Only a subset of the parameters need be |
| | specified (default values or the previous values will be |
| | used). |
| ImgSecGetParams ( ) | Returns the correct Image Security Parameters. |
| ImgSecDeleteKey ( ) | Deletes a Keypair. The service fails if no Keypair exists. |
| | If a Certificate exists, it is deleted also. |
| ImgSecGetKey ( ) | Gets information and state for the specified KeyPairNum. |
| ImgSecActivate ( ) | Activates Image Security (when Security Level 2 is in |
| | effect). |
| ImgSecReset ( ) | Resets Image Security back to the factory settings (all |
| | key-pairs, Certificates are destroyed). To be used if, for |
| | example, a corruption occurs or if the Image Security |
| | password is simply forgotten. |
| InstallFile ( ) | This method loads a file onto the file system where the |
| | service resides. This method may be used to install the |
| | client processing rules plug-in module (and initialization |
| | file), as well as updated system files. |

In an embodiment, methods in device services 135 and application services 130 may be called by sending a message according to Simple Object Access Protocol (SOAP) in an XML format generally also in accord with WSDL, mentioned above. For example, a segment of XML that might be used to call the “GetDocument( )” method listed above could be defined as follows:

```
<xs:element name=“GetDocument”>
  <xs:complexType>
    <xs:sequence>
      <xs:element minOccurs=“1” maxOccurs=“1”
        name=“GetDocumentData” type=“tns:CTGetDocumentData” />
    </xs:sequence>
  </xs:complexType>
</xs:element>
<xs:complexType name=‘CTGetDocumentData’>
  <xs:sequence minOccurs=‘1’ maxOccurs=‘1’>
    <xs:element name=‘Timeout’ type=‘xs:integer’ default=‘1000’/>
  </xs:sequence>
</xs:complexType>
```

The “timeout” element is a value is in milliseconds, e.g., the “GetDocument( ) method must respond to the above call in 1000 milliseconds. In some embodiments, if the timeout value used to call “GetDocument( )” is larger than a HTTP timeout value, the method request will timeout at the HTTP level before this timeout is reached.

In addition, a segment of XML that could be output by device service 135 as the result of a call to the GetDocument( ) method could be:

```
  <xs:element name=‘GetDocumentResponse’>
    <xs:complexType name=‘CTGetDocumentResult’>
      <xs:sequence minOccurs=‘1’ maxOccurs=‘1’>
        <xs:element name=‘Status’ type=‘tns :CTisStatus’ />
        <xs:element name=‘DocumentResult’
        type=‘tns :CTDocumentResult’ />
        <xs:element name=“ResultCode”
        type=“tns:STResponseCode” minOccurs=“0”
maxOccurs=“1” default =“Success”/>
        <!-- Low-level exception information that may be useful
        to service personnel -->
        <xs:element name=“Detail” type=“xs:string”
        minOccurs=“0” maxOccurs=“1” />
      </xs:sequence>
    </xs:complexType>
  </xs:element>
```

An explanation of the elements in the above segment of XML is found in Table 3 below.

### VI. Exemplary Device Services Data Elements

In an embodiment, methods in device service 135, and events generated by device service 135, accept as input and provide as output XML documents including elements formatted according to certain defined data types. These data types are sometimes referred to as “complex types” because they may include more than one element. Further, as seen in Table 2 below, some complex types are nested within other complex types, such nesting being well known with respect to XML documents. In this exemplary embodiment, defined complex data types include, but, as should be clear from Table 2, are not limited to, the following:

A ResponseCode data type allows for response code values to be returned from methods in device service 135.

A ServiceState data type describes the state of the called device service 135.

A TransportState data type described the state of a device 120 or 150 associated with the called device service 135.

A ServiceStatus data type provides status information concerning a device 120 or 150 associated with the called device service 135.

A Capabilities data type is used to describe the functional capabilities of the document processing device 120 or 150 associated with the service 135.

A Configuration data type defines the configuration of a device service 135 and a device 120 or 150 that the service 135 is controlling. The Configuration data type includes other complex types, as seen in Table 3 below.

Table 2 lists data types used for methods provided, and events generated, by device services 135. Table 2 further lists elements included within each data type. These elements may be included in XML messages to and from device service 135. References to a “device” in Table 2 are to a device 120 or 150.

TABLE 2

| | Element or Nested Complex | |
|---|---|---|
| Complex Type | Type | Meaning or Possible Values of Element |
| Response Code | Success | Method was successfully executed. |
| Response Code | UnspecifiedError | An unspecified error occurred. |
| Response Code | InUseError | The service request could not be |
| | | completed because the service was busy. |
| | | Retry the request later. |
| Response Code | FatalError | Fatal error. Power off the device and retry |
| | | the operation. |
| Response Code | StateError | The service was not in the proper state for |
| | | the given method. |
| Response Code | OutOfMemoryError | The service did not have sufficient |
| | | memory available to complete the |
| | | request. |
| Response Code | FileIoError | An error occurred during a file I/O |
| | | operation. |
| Response Code | FileFormatError | A given file could not be processed |
| | | because it was in an |
| | | unknown/unsupported format. |
| Response Code | SensorError | A sensor in the track in the device that |
| | | moves documents through the device |
| | | failed. Clean the track and retry the |
| | | operation. |
| Response Code | ImageFramingError | The image was not successfully captured |
| | | because the document edges were not |
| | | properly detected. |
| Response Code | ImageAcquisitionError | The image data is missing/corrupt. |
| Response Code | ImageQualityError | An error occurred while performing image |
| | | quality analysis. |
| Response Code | DocumentTrackingError | The device was unable to process the |
| | | document as it ran through the track. Stop |
| | | the device and refeed the document. |
| Response Code | HardwareError | A hardware error occurred. Retry the |
| | | operation. If the problem persists, |
| | | hardware servicing may be required. |
| Response Code | DoubleDocument | Two or more documents were detected |
| | | coming out of the feeder in the device |
| | | simultaneously. |
| Response Code | DocumentInTrack | An unexpected document was detected in |
| | | the device's document track. Clear the |
| | | track and retry the operation. |
| Response Code | Jam | One or more documents have jammed in |
| | | the track. |
| Response Code | FeederJam | A jam has been detected at the feeder. |
| Response Code | ImagerJam | A jam has been detected at the imager. |
| Response Code | EndorserJam | A jam has been detected at the endorser. |
| Response Code | DocumentTooLong | The document length exceeds the |
| | | maximum allowable length. |
| Response Code | DocumentTooShort | The document length is below the |
| | | minimum allowable length for the track. |
| Response Code | ApplicationForcedStop | The application requested that document |
| | | processing should immediately stop. |
| Response Code | UnspecifiedImageSecurityError | An error occurred in the Image Security |
| | | module. |
| Response Code | CertificateExpired | The current security certificate stored in |
| | | the device has expired. |
| Response Code | CertificateYetToStart | The current certificate stored in the device |
| | | is not valid yet. |
| Response Code | ImageSecurityAuthenticationError | The request for an image or information |
| | | about an image could not be |
| | | authenticated. |
| Response Code | ImageSecurityCorrupt | Invalid data was detected on the image |
| | | security secure storage media. |
| Response Code | ImageSecurityInternalError | A fatal image security error occurred. |
| Response Code | ImageSecurityNotConfigured | No password has been configured for |
| | NoPassword | image security administration. |
| Response Code | IncorrectImageSecurityAdmin | An incorrect password was used. |
| | Password | |
| Response Code | NewPasswordMinRequirement | The password did not meet the minimum |
| | | requirements. |
| Response Code | NewPasswordNotAllowed | The password entered is not allowed. |
| Response Code | InvalidKeypair | The key pair is invalid. |
| Response Code | KeypairDoesNotExist | The key pair does not exist. |
| Response Code | InvalidUid | The user ID is invalid. |
| Response Code | UidInsufficient | The user ID is insufficient. |
| Response Code | CertificateKeypairMismatch | The keypair does not match the digital |
| | | security certificate in the device. |
| Response Code | UnableToParseCertificate | The digital security certificate in the |
| | | device cannot be parsed. |
| Response Code | MissingCertificate | The digital security certificate in the |
| | | device is missing. |
| Response Code | UnrecognizedSecurityParameter | The security parameter is not recognized. |
| Response Code | InvalidSecurityParameter | The security parameter is not valid. |
| ServiceState | Ready | The service is ready to respond to client |
| | | requests. |
| ServiceState | DocumentProcessing | The service is ready to process |
| | | documents. |
| TransportState | Offline | The device is not able to respond to |
| | | commands. |
| TransportState | ReadyToFlow | The device is waiting and ready to flow |
| | | documents. |
| TransportState | Flowing | The device is flowing documents. |
| TransportState | ExceptionInProgress | The device has encountered an exception |
| | | (jam, processing error, etc.). |
| ServiceState | ResponseCode | The response code for the invoked |
| | | method. |
| ServiceState | DetailCode | A detailed code. |
| ServiceState | ServiceState | The state of the web service. |
| ServiceState | TransportState | The state of the document processing |
| | | transport device (e.g., device 120 or 150). |
| ServiceState | FeederEmpty | The state of the transport's feeder (true if |
| | | no documents present, false if documents |
| | | are present). |
| ServiceState | DocumentsQueued | The number of complete documents |
| | | currently queued in the service. If >0, |
| | | then a subsequent call to GetDocument( ) |
| | | will return a document. |
| Capabilities | DeviceIdentifier | An informational string identifying the |
| | | transport. |
| Capabilities | SoftwareLevel | An informational string identifying the |
| | | level of service software on the device. |
| Capabilities | StartButton | Indicates whether or not a Start/Stop |
| | | button is available on the device. |
| Capabilities | FrontBlackWhiteImagers | Indicates the number of front bitonal |
| | | (usually CCITT) images that can be |
| | | generated by the device. |
| Capabilities | FrontGrayImagers | Indicates the number of front gray (usually |
| | | JPEG) images that can be generated by |
| | | the device. |
| Capabilities | FrontColorImagers | Indicates the number of front color images |
| | | that can be generated by the device. |
| Capabilities | FrontSnippetImagers | Indicates the number of front snippet |
| | | images that can be generated by the |
| | | device. |
| Capabilities | RearBlackImagers | Indicates the number of rear bitonal |
| | | (usually CCITT) images that can be |
| | | generated by the device. |
| Capabilities | RearGrayImagers | Indicates the number of rear gray (usually |
| | | JPEG) images that can be generated by |
| | | the device. |
| Capabilities | RearColorImagers | Indicates the number of rear color images |
| | | that can be generated by the device. |
| Capabilities | RearSnippetImagers | Indicates the number of rear snippet |
| | | images that can be generated by the |
| | | device. |
| Capabilities | FrontGrayCameraResolutions | Indicates the supported camera |
| | | resolution(s) in Dots Per Inch (DPI) for the |
| | | front grayscale camera. |
| Capabilities | FrontBlackWhiteCameraResolutions | Indicates the supported camera |
| | | resolution(s) in Dots Per Inch (DPI) for the |
| | | front black/white camera. |
| Capabilities | FrontColorCameraResolutions | Indicates the supported camera |
| | | resolution(s) in Dots Per Inch (DPI) for the |
| | | front color camera. |
| Capabilities | FrontSnippetCameraResolutions | Indicates the supported camera |
| | | resolution(s) in Dots Per Inch (DPI) for the |
| | | front snippet camera. |
| Capabilities | RearGrayCameraResolutions | Indicates the supported camera |
| | | resolution(s) in Dots Per Inch (DPI) for the |
| | | rear grayscale camera. |
| Capabilities | RearBlackWhiteCameraResolutions | Indicates the supported camera |
| | | resolution(s) in Dots Per Inch (DPI) for the |
| | | rear black/white camera. |
| Capabilities | RearColorCameraResolutions | Indicates the supported camera |
| | | resolution(s) in Dots Per Inch (DPI) for the |
| | | rear color camera. |
| Capabilities | RearSnippetCameraResolutions | Indicates the supported camera |
| | | resolution(s) in Dots Per Inch (DPI) for the |
| | | rear snippet camera. |
| Capabilities | SnippetCameraResolutions | Indicates the supported camera |
| | | resolution(s) in Dots Per Inch (DPI) for the |
| | | snippet camera. |
| Capabilities | FrontEndorsers | Indicates the number of front endorsers |
| | | available on the device. |
| Capabilities | RearEndorsers | Indicates the number of rear endorsers |
| | | available on the device. |
| Capabilities | EndorserFonts | A list of supported endorser fonts. |
| Capabilities | Encoders | Indicates the number of Magnetic Ink |
| | | Character Recognition (MICR) encoding |
| | | modules available on the device. |
| Capabilities | RedFilters | Indicates the number of red drop out |
| | | filters available. |
| Capabilities | MicrReaders | Indicates the number of MICR readers |
| | | available on the device. |
| Capabilities | MicrTypes | A list of MICR types that the device |
| | | supports. |
| Capabilities | OcrReaders | Indicates the number of OCR readers |
| | | available on the device. |
| Capabilities | OcrFonts | A list of supported OCR fonts. |
| Capabilities | Leds | Indicates the number of application |
| | | accessible LEDs. |
| Capabilities | Audio | Indicates whether or not the device is |
| | | capable of playing audio files. |
| Capabilities | TextDisplay | Indicates whether or not the device is |
| | | capable of rendering text output. |
| Capabilities | MagneticStripeReaders | Indicates the number of magnetic stripe |
| | | readers available on the device. |
| Capabilities | Pockets | Indicates the number of pockets available |
| | | on the device. |
| Configuration | FeederConfiguration | Configuration information for the feeder |
| | | device. |
| Configuration | ReaderConfiguration | Configuration information for the |
| | | reader(s). |
| Configuration | ImageConfiguration | Configuration information for the |
| | | imager(s). |
| Configuration | ImageQualityConfiguration | Configuration information for the Image |
| | | Quality feature. |
| Configuration | EndorseConfiguration | Configuration information for the |
| | | endorser(s). |
| Configuration | UnitConfiguration | General configuration information for the |
| | | TIS device. |
| FeederConfiguration | DisableStartButton | If true, the start button on the device is |
| | | ignored. |
| FeederConfiguration | AutofeedTimeout | A value in milliseconds specifying the |
| | | length of time to wait after documents |
| | | have been detected in the reader before |
| | | an automatic feed will occur. Set this to 0 |
| | | to disable automatic feeding. |
| FeederConfiguration | DoubleDocumentLengthThreshold | A value that specifies the maximum |
| | | length of a document. If a document is |
| | | detected coming out of the feeder that is |
| | | longer than this value, a double document |
| | | error condition will be reported. Set this to |
| | | 0 to disable double document detected |
| | | based on length. This value may be |
| | | specified in millimeters or 1/10 of inches |
| | | (determined by the |
| | | /Configuration/UnitConfiguration/Measurement |
| | | Units configuration element.) |
| ReaderConfiguration | TruncationLength | Sets the length of the document that is |
| | | read. This value is in tenths of inches or |
| | | millimeters. A value of 0 means to read |
| | | the entire document. |
| ReaderConfiguration | PreserveSpaces | If true, keep space characters in the |
| | | returned codeline. If false, space |
| | | characters are removed before returning |
| | | the codeline to the application. |
| ReaderConfiguration | MicrReader | Configuration for the MICR reader. |
| ReaderConfiguration | OcrReader | Configuration for the Optical Character |
| | | Reader (OCR). |
| MicrReader | Type | The type of the MICR reader. |
| MicrReader | Enabled | True to enable this reader, false to disable |
| | | the reader. |
| MicrReader | MaxChars | Maximum number of characters to |
| | | recognize. |
| MicrType | E13B | E13B MICR option. |
| MicrType | CMC7 | CMC7 MICR option. |
| MicrType | E13BWithOcrAssist | E13B MICR option combined with OCR |
| | | results. In order to use this setting, one of |
| | | the OCR readers MUST be configured |
| | | with the proper Frame element for the |
| | | codeline, and the OCR reader's |
| | | Vendor/Font element should be set to |
| | | “MICROCR”. |
| MicrType | Auto | Lets the hardware choose the reader type |
| | | based on the input documents. |
| OcrReader | Enabled | True to enable this reader, false to disable |
| | | the reader. |
| OcrReader | Font | OCR font name to use for this reader. |
| | | Note that the client can retrieve a list of |
| | | supported fonts for the device by using |
| | | the GetCapabilities( ) API. |
| OcrReader | MaxChars | Maximum number of characters to |
| | | recognize. |
| OcrReader | Frame | Defines the rectangular region of the |
| | | document where the OCR information |
| | | resides. |
| OcrReader | Vendor | Vendor specific OCR options. |
| ReaderFrame | | |
| VendorOcrReader | InitialCharacterSet | Defines the character set within the |
| | | selected Font for initial use. |
| | ReportFontSwitching | Defines whether or not the service should |
| | | report if a font switch occurred. If true, the |
| | | reader will insert special codes within the |
| | | codeline returned to the application for |
| | | each font switch that is detected while |
| | | reading the document. 0xC0 and 0xC1 |
| | | indicate a switch based on the first or |
| | | second switch strings, while 0xD0-0xD7 |
| | | indicate a switch based on the first |
| | | through 8^{th} switch position. |
| | Switch | Font switching information. |
| VendorOcrFont | | Vendor specific OCR fonts. |
| FontSwitch | String | A string of 3 characters or less (no space |
| | | characters) that trigger a switch from the |
| | | InitialCharacterSet to the CharacterSet |
| | | within a document. To switch fonts based |
| | | on position instead of by string, leave out |
| | | this element. |
| | Position | The horizontal position (in OCR units) |
| | | measured from the leading edge of the |
| | | document at which the OCR reader |
| | | switches to the character set indicated by |
| | | CharacterSet. Leave this element out to |
| | | switch based on a string instead of by |
| | | position. |
| | CharacterSet | Character set that the system switches to |
| | | if the String or Position triggers a switch. |
| ImageConfiguration | | |
| FrontImageConfiguration | | |
| EndorseConfiguration | | |
| PresetEndorsement | FixedEndorsementEnabled | Set this to ‘true’, and set the remaining |
| | | fields to valid values in order to apply a |
| | | fixed (pre-determined) endorsement to all |
| | | documents. Set this to ‘false’ and the |
| | | endorsement options will be set by the |
| | | application processing rules. |
| PresetEndorsement | PositionReference | The Position element is relative to the |
| | | edge specified by this value. |
| PresetEndorsement | Position | Specifies the position to apply the |
| | | endorsement. |
| PresetEndorsement | FontName | Specifies the font file name. One of: |
| | | “5cpi” |
| | | “10cpi” |
| | | User defined font. (See |
| | | InstallFile API for information on |
| | | configuring a user font file). |
| PresetEndorsement | EndorseText | Specifies the text string to endorse on the |
| | | document. |
| UnitConfiguration | WebServicesConfiguration | Configuration data for the web service. |
| UnitConfiguration | MeasurementUnits | Specifies the units for all configuration |
| | | elements that specify a measurement. |
| UnitConfiguration | AlertList | A list of user interface settings that are |
| | | triggered by various track events. |
| UnitConfiguration | SndpUnitConfiguration | Configuration data for the device. |
| WebServicesConfiguration | ReturnExceptionDocuments | Set this to true to enable GetDocument( ) |
| | | to return exception documents. |
| WebServicesConfiguration | ServerMtomEnabled | Set this to true to enable Message |
| | | Transmission Optimization Mechanism |
| | | (Mtom) on outgoing SOAP messages. |
| WebServicesConfiguration | ApplicationPorts | Defines port numbers for services running |
| | | on the TIS device. |
| SndpUnitConfiguration | GrayStretchImages | Specifies whether grayscale images are |
| | | enhanced by “stretching” the gray level |
| | | output across the full 0-255 range. Also |
| | | performs some contrast reduction. |
| | | Applies to all grayscale images captured |
| | | by this camera. |
| SndpUnitConfiguration | DisableAutomaticDoubleDocument | Specifies whether or not the built-in |
| | Detection | double document detection algorithm is |
| | | enabled. If the application is using the |
| | | sensor values in the document processing |
| | | rules to apply its own double document |
| | | detection algorithm, this setting should be |
| | | ‘true’. |
| SndpUnitConfiguration | DisableCapiBroadcast | Set this value to disable the device from |
| | | sending UDP broadcasts that attempt to |
| | | locate a CAPI/CLIB/DLL Manager |
| | | program on the local network. |
| SndpUnitConfiguration | SntpServerAddress | This is the address of a Simple Network |
| | | Time Server. This must be configured in |
| | | order for the SNDP device to acquire the |
| | | current time. |
| SndpUnitConfiguration | WebServicesConfiguration | Specifies settings related to the device |
| | | service. |
| SndpUnitConfiguration | NetworkConfiguration | Specifies network settings for the device. |
| NetworkConfiguration | HostName | Network name of the device. |
| NetworkConfiguration | DHCP | Specifies whether or not DHCP should be |
| | | used to acquire a network address. |
| NetworkConfiguration | Static | If DHCP is not used, must be present to |
| | | specify the static address configuration. |
| AlertList | Alert | Specifies user interface elements |
| AlertList | TrackEvent | Specifies the event associated with this |
| | | alert. |
| AlertList | AudioAlert | Specifies either an audio filename, or an |
| | | empty string to use the default audio file. |
| AlertList | LedAlert | Specifies the state of the operator LED. |
| AlertList | TextAlert | Specifies text to display to the operator. (If |
| | | supported by device.) |

### VII. Exemplary Events

Table 3 provides an exemplary but certainly not exhaustive list of events that may be included in messages 215 and 220 from device service 135 in an embodiment.

TABLE 3

| Event | Description |
|---|---|
| DocumentResult | The DocumentResult event is generated after a document has been |
| | completely processed by a device 120 or 150, and includes details about a |
| | document and its processing, possibly including an image 210. |
| Exception | The Exception event is generated when a device exception is encountered. |
| | Some embodiments similarly include a PowerOff event. |
| Power On | The Power On event is generated when the device powers on. Some |
| | embodiments similarly include a PowerOff event. |
| Warning | The Warning event is generated when a device warning needs to be issued, |
| | such as a warning that a device is low on ink, a feeder is empty, camera |
| | lighting has degraded and therefore image quality may suffer, that a |
| | security certificate is nearing expiration, etc. |

Table 4 provides an exemplary list of elements that may be included in a DocumentResult event, according to an embodiment. It is to be understood that not all elements listed below must be, or generally are, included in a particular event, and further that other elements are possible.

TABLE 4

| Complex Type | Element | Description |
|---|---|---|
| DocumentResult | SorterIdentifier | Contains the identity of the device that sent |
| | | the event. |
| DocumentResult | Document | Information about the document. |
| DocumentResult | ProcessingRulesResult | This is a result that is returned by the |
| | | application-defined processing rules that were |
| | | invoked after the document codeline was read |
| | | by a device. |
| SorterIdentifier | HostName | Network host name of the device. |
| SorterIdentifier | SerialNumber | Serial number of the device. |
| Document | DocumentIdentifier | Identifies the document. |
| Document | DocumentStatus | Processing status of the document. |
| Document | Codelines | Contains the document codeline data. |
| Document | ImageList | List of images for this document. |
| DocumentIdentifier | Uuid | A unique device generated identifier. |
| | | Conforms to the IETF UUID specification |
| DocumentIdentifier | SequenceNumber | A device generated sequence number |
| | | identifying the document. The identifier is |
| | | unique within the device (provided the device |
| | | is not power-cycled). |
| DocumentIdentifier | ApplicationIdentifier | An identifier provided by the application |
| | | processing rules. |
| DocumentStatus | Success | Document was successfully processed. |
| DocumentStatus | Deleted | This status is returned when an item is in an |
| | | exception. The operator will have to refeed the |
| | | item since images were not stored for the item |
| | | and the item may not have been endorsed. |
| DocumentStatus | ImageIncomplete | Is set if the image was not captured as |
| | | requested. |
| DocumentStatus | FrontEndorseIncomplete | Set if the front endorsement was not set as |
| | | requested. |
| DocumentStatus | RearEndorseIncomplete | Set if the rear endorse operation was not |
| | | completed as requested. |
| DocumentStatus | PocketIncomplete | This is set if a device was unable to pocket |
| | | the document as requested by the application. |
| DocumentStatus | MicrIncomplete | Set if the MICR operation was not completed |
| | | as requested. |
| DocumentStatus | MsrIncomplete | Set if the magnetic stripe read was not |
| | | performed as requested. |
| Codelines | Codelines | Codeline data |
| MicrCodeline | MicrCodeline | Codeline data |
| OcrCodeline | OcrCodeline | Codeline data |
| ImageList | ImageList | Codeline data |
| Image | Format | Specifies the format of the image data. This |
| | | would normally be equated with the image's |
| | | ‘File type’, or the MIME image type. |
| Image | Compression | Specifies the compression method used for |
| | | the image. |
| Image | Depth | |
| Image | Side | Identifies the side of the document. |
| Image | ImageBytes | The image byte stream. The format of the |
| | | data is determined by the Format element. |
| Image | Security | Digital signature and certificate information for |
| | | the image. |
| Image | QualityResults | Image Quality analysis results, threshold |
| | | settings and metric data. |

Table 5 provides an exemplary list of elements that may be included in a Warning event, according to an embodiment. Again, it is to be understood that not all elements listed below must be, or generally are, included in a particular event, and further that other elements are possible.

TABLE 5

| Element | Description |
|---|---|
| RearEndorseCartridgeLow | The endorser ink cartridge is getting low on ink. Note that in order |
| | for this warning to work properly, the application MUST reset the |
| | endorser ink drop count using a ResetStatistics method when an |
| | ink cartridge is installed by the operator. |
| FeederEmpty | The feeder state has transitioned from not empty to empty. |
| ImageCompensation | The lighting of the camera has reached a level where the image |
| | quality could be marginal. Continuing to operate with marginal |
| | lighting will result in poor images to be captured and lowered OCR |
| | read rates. This could be caused by a failure in the camera lighting |
| | or excessive dirt or dust in the image area of the track (on the |
| | glass or the removable track wall). Clean the track walls in the |
| | image area. |
| CertificateNearingExpiration | The certificate used for signing images is nearing its expiration |
| | date. |
| CertificateIsTest | The certificate in use for signing images is not a production |
| | certificate, it is a test certificate. |

### Conclusion

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising:
a plurality of document processing devices;
a plurality of device services, each of the device services associated with one of the document processing devices and configured to generate information concerning a document processed by the one of the document processing devices; and
a plurality of client interfaces, each of the client interfaces included in one of the device services;
wherein each device service is configured to accept subscriptions from a plurality of clients and to perform at least one of (a) publishing an event to the clients based on at least one of a status of the document processing device and the information and (b) providing an instruction to the document processing device based on a message from one of the plurality of clients.

2. The system of claim 1, wherein the information includes an image.

3. The system of claim 1, further comprising a computer that is connected to at least one of the document processing devices and that includes at least one of the device services.

4. The system of claim 1, further comprising a plug-in module included in at least one of the device services, wherein the plug-in module provides rules for processing documents.

5. The system of claim 1, further comprising one or more application services in selective communication with at least one of the device services and at least one of the clients.

6. The system of claim 5, wherein the application services include at least one of a configuration manager, a test application, an image analyzer, a discovery manager, an entitlement manager, an exception handler, an image security manager, and a reporting application.

7. The system of claim 1, further comprising a network connecting the device services and the clients.

8. A method, comprising:
generating information concerning documents processed by a plurality of document processing devices;
accepting subscriptions from a plurality of clients; and
performing at least one of (a) publishing events to the clients based on at least one of statuses of the document processing devices and the information and (b) providing instructions to the document processing devices based on messages from the clients.

9. The method of claim 8, the information including an image.

10. The method of claim 8, further including device services in the document processing devices.

11. The method of claim 8, further comprising connecting computers that include device services to each of the document processing devices.

12. The method of claim 11, further comprising installing a plug-in module in at least one of the device services, wherein the plug-in module provides rules for processing documents.

13. The method of claim 8, further comprising selectively communicating with one or more application services.

14. The method of claim 13, wherein the application services include at least one of a configuration manager, a test application, an image analyzer, a discovery manager, an entitlement manager, an exception handler, an image security manager, and a reporting application.

15. The method of claim 8, further comprising using a network to communicate with the clients.

16. A system, comprising:
a document processing device;
a device service configured to generate information concerning a document processed by the document processing device;
a client interface included in the device service that is configured to perform at least one of (a) publishing an event to a plurality of clients based on at least one of a status of the document processing device and the information and (b) providing an instruction to the document processing device based on a message from one of the plurality of clients; and
one or more application services in selective communication with the device service and at least one of the clients.

17. The system of claim 16, wherein the information includes an image.

18. The system of claim 16, further comprising a computer that is connected to the document processing device and that includes the device service.

19. The system of claim 16, further comprising a plug-in module included in the document device service, wherein the plug-in module provides rules to the document processing device for processing documents.

20. The system of claim 16, further comprising one or more application services in selective communication with the device service and at least one of the clients.

21. The system of claim 20, wherein the application services include at least one of a configuration manager, a test application, an image analyzer, a discovery manager, an entitlement manager, an exception handler, an image security manager, and a reporting application.

22. The system of claim 20, further comprising a network connecting the device service and the clients.

23. A set of computer-executable instructions tangibly embodied on a computer-readable medium, the instructions comprising instructions for:
generating information concerning documents processed by a plurality of document processing devices;
accepting subscriptions from a plurality of clients; and
performing at least one of (a) publishing events to the clients based on at least one of statuses of the document processing devices and the information and (b) providing instructions to the document processing devices based on messages from the clients.
